(19) United States
(12) Patent Application Publication
(10) Pub. No.: US 2026/0234974 A1
(43) Pub. Date: Aug. 13, 2026

(54) DEVICE FOR GUIDING A SLIDING DOOR OF A VEHICLE

(71) Applicant: FLEXIS, BOULOGNE-BILLANCOURT (FR)

(72) Inventors: Philippe GAILLARD, LE CHESNAY (FR); Bérénice RAPIOR, Villiers Saint Frédéric (FR)

(21) Appl. No.: 18/855,797

(22) PCT Filed: Apr. 3, 2023
(86) PCT No.: PCT/EP2023/058649

§ 371 Date: Jul. 15, 2025

(30) Foreign Application Priority Data
Apr. 12, 2022 (FR) FR2203355

(51) Int. Cl. E05D 15/10; B60J 5/06

(52) U.S. Cl. CPC E05D 15/1047; B60J 5/06; E05D 2015/1057; E05Y 2201/692; E05Y 2900/531

(57) ABSTRACT

A device for guiding a sliding door of a vehicle, in particular a motor vehicle, the device including an axial guiding means made up of at least a first substantially rectilinear rail along which a carriage is able to slide, and an angular guiding means made up of a second rail, in particular, a curved end, having a portion that is sloped relative to the first rail, and a connecting arm for connecting to the door. The guide device is characterized in that the first rail extends in a plane, which plane is, in particular substantially horizontal, in which the second rail moves such that the connecting arm connecting the door to the guide device extends only under each of the first and second rails.

### CROSS-REFERENCE TO RELATED APPLICATIONS

This application claims benefit under 35 USC § 371 of PCT Application No. PCT/EP2023/058649 entitled METHOD FOR TRAINING A PREDICTION ALGORITHM AND ASSOCIATED DEVICES, filed on Jun. 30, 2022 by inventor Pierre-Yves Lagrave. PCT Application No. PCT/EP2023/058649 claims priority of French Patent Application No. 22 03355, filed on Apr. 12, 2022.

### FIELD OF THE INVENTION

The present invention relates to a device for guiding a sliding door on a vehicle body, in particular a motor vehicle, comprising an axial guiding means and an angular guiding means enabling the door to move from a closed position wherein the door closes an opening by being substantially flush with the surrounding parts of the vehicle body and an open position wherein the door is pushed outwards and moved toward the rear or the front of the vehicle substantially away from the opening.

### BACKGROUND OF THE INVENTION

Conventionally, in such sliding door movements, the front part of the door is guided by means of a guide rail having an end curved toward the inside of the passenger compartment of the vehicle, the door being connected to the guide rail by means of a sliding carriage, linked to the front of the door to guide the door into alignment with the bodywork during the closing thereof and to push the door towards the outside of the bodywork when during the opening thereof. Such a device, with a curved rail penetrating into the passenger compartment, nevertheless has the drawback of having a large transverse bulk volume, the latter being at least equal to the lateral travel of the sliding door, which generates an unaesthetic protuberance in the zone of the passenger compartment facing the rail. A sliding door guide device is known from FR2779996 which provides a large travel of lateral sliding door and a reduced transverse bulk volume, in order to make possible a discreet integration of the guide device, and which would be easy and economical to make. Such device comprises an arm pivotally mounted on the door and slidably mounted at two distinct points along a first and a second guide rail, respectively, which have different trajectories to ensure the pivoting of the arm so as to move the door away from the bodywork in the open position and to reduce the transverse bulk volume for the arm in the closed position. However, it was noted that the superposition architecture of the first and second guide rails one above the other constrains the pivoting arm to move vertically between the first and second guide rails which, for reasons of bulk volume [are] close to each other, which tends to limit the vertical adjustment position of the door by a displacement of the connecting arm relative to the rails at the door. Even though the transverse bulk volume has been reduced compared to a conventional single-rail solution, a geometry that is difficult to integrate on a body has been identified because of the placement of the first and second rails one above the other. An improvement solution is thus necessary due to the above-mentioned drawbacks.

### SUMMARY OF THE INVENTION

The goal of the present invention is therefore to propose a sliding door guide device which provide a large travel of the sliding side door and requires a reduced bulk volume, both transversely and vertically, in order to make possible discreet integration of the guide device, while being easy and economical to make.

The subject matter of the invention is a device for guiding a sliding door of a vehicle, in particular a motor vehicle, the device comprising an axial guiding means made up of at least a first substantially rectilinear rail along which a carriage is able to slide, and an angular guiding means made up of a second rail, in particular, a curved end, having a portion that is sloped relative to the first rail, and a connecting arm for connecting to the door. The guide device is characterized in particular by the fact that the first rail extends in a plane, in particular substantially horizontal, wherein the second rail moves in such a way that the connecting arm connecting the door to the guide device extends only under each of the first and second rails.

According to other features and advantages of the invention, the guide device comprises the following features taken separately or in combination with each other:
the first and second rails each comprise a rectilinear portion, in particular a rear portion, and in that same are assembled to each other, in particular by welding, at the rear portion thereof;
same comprises a rail module comprising the first and second rails; the module can be manufactured by means of folding metal sheets made of steel, in particular stainless steel,
same comprises a rail module comprising the first and second rails; the module can be manufactured by means of an operation of extrusion of an alloy, in particular an aluminum alloy;
the rail module comprises rear portions of rails with a substantially rectilinear profile;
each of the first and second has a profile with a substantially inverted-U-shape, and in that one of the branches parallel to one the first and second rails is directly connected to one of the parallel branches of the other of the first and second rails;
said axial guiding means comprises a carriage mounted apt to slide along the first rail by means of a pair of rollers linked to a plate extending under each of the first and second rails, the plate including, in particular, an off-center portion on which a rotation link in relation with said angular guiding means is positioned;
said angular guiding means comprises a roller linked to the connecting arm and mounted apt to rotate along second rail so that the movement of the roller along the sloped portion of the second rail generates a rotation of the connecting arm about the carriage, in particular about a first axis of rotation;
the connecting arm of said angular guiding means comprises branches parallel to each other, one end of the arm being connected to said axial guiding means via a first rotation shaft coaxial with said first axis of rotation and an opposite end of the arm is connected to the door via a mounting plate connected to a second rotation shaft coaxial with a second axis of rotation and fastened onto the door, in particular by screws, each of the first and second rotation shaft extending perpendicularly through said parallel branches;
the opposite end of the connecting arm comprises a portion with a substantially U-shaped cross-section;
the mounting plate, the connecting arm and the carriage, extend correspondingly in planes parallel to each other, in particular substantially horizontal, under each of the guide rails;
each of the rollers is mounted on a rod, in that the height of the roller is smaller than the height of the branches parallel to the first and second rails, so that the gap, in particular vertical, separating the mounting plate and/or the connecting arm and/or the carriage of the first rail and/or of the second rail may be variable to make possible an adjustment of the door relative to an opening on the body side.

The invention also relates to a vehicle having a sliding door, in particular a lateral door, a body side delimiting an opening apt to be closed by the door, which is characterized in that same comprises the guide device as described hereinabove.

### BRIEF DESCRIPTION OF FIGURES

The goals, aspects and advantages of the present invention will be better understood from the following description of an embodiment making reference to the appended drawings, wherein:

FIG. 1 is a three-quarter perspective view of a guide device for a sliding door according to the invention;

FIG. 2 is an enlargement of the guide device shown in FIG. 1 with the details of the constituent elements of the device when the door is in the closed position;

FIG. 3 is a three-quarter perspective view of the device shown in FIG. 2.

### DETAILED DESCRIPTION OF PREFERRED EMBODIMENTS

Only the elements needed for the understanding of the invention have been shown. To facilitate the reading of the drawings, the same elements have the same references from one figure to another.

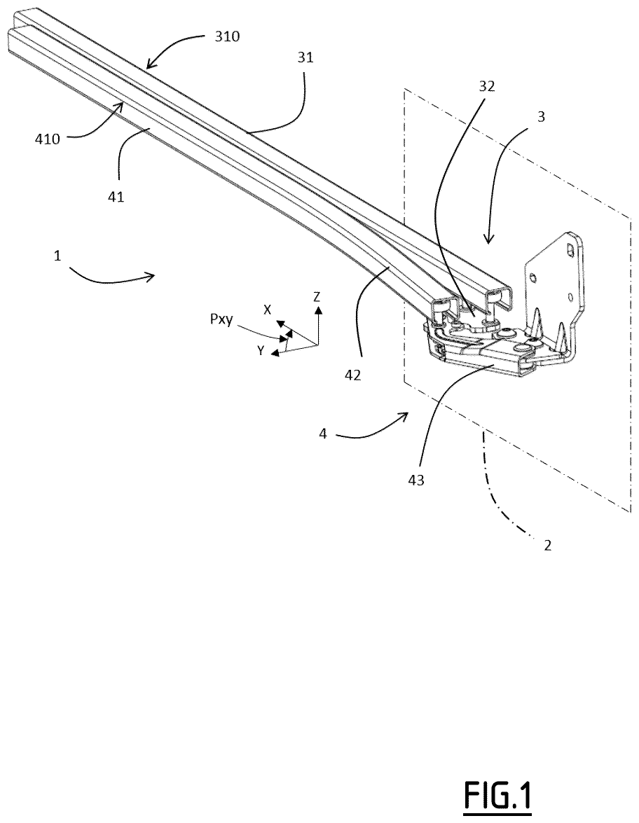

The description of the figures is made taking into account an orthonormal reference system of axes X, Y and Z associated with a vehicle on which the device according to the invention is intended to be mounted in order to make possible the movement of a door, where the axis X corresponds to the longitudinal axis from the front to the rear of a vehicle, the axis Y corresponds to a transverse axis from the left side to the right side of the vehicle, and the axis Z corresponds to a vertical axis going from the bottom to the top of the vehicle. FIG. 1 shows a device 1 for guiding the front part of a sliding door 2, the device being in the closed position state of the door. The device has an axial guiding means 3 adjacent to an angular guiding means 4, arranged on the lower part of the frame of an opening. Said axial guiding means 3 comprises a first guide rail 31, on which slides a carriage 32 with rollers 33, which is connected to the door 2 by a connecting arm 43 rotatably mounted both on the carriage of said axial guiding means 3, and on a mounting plate 5 dedicated to fastening the door to said guide device 1.

The angular guiding means 4 comprises a second rail 41, a front part of which is composed of a sloped portion 42, which may be rectilinear, curved, or even of the double-curved type. The angular guiding means 4 is suitable for the kinematics of door closing.

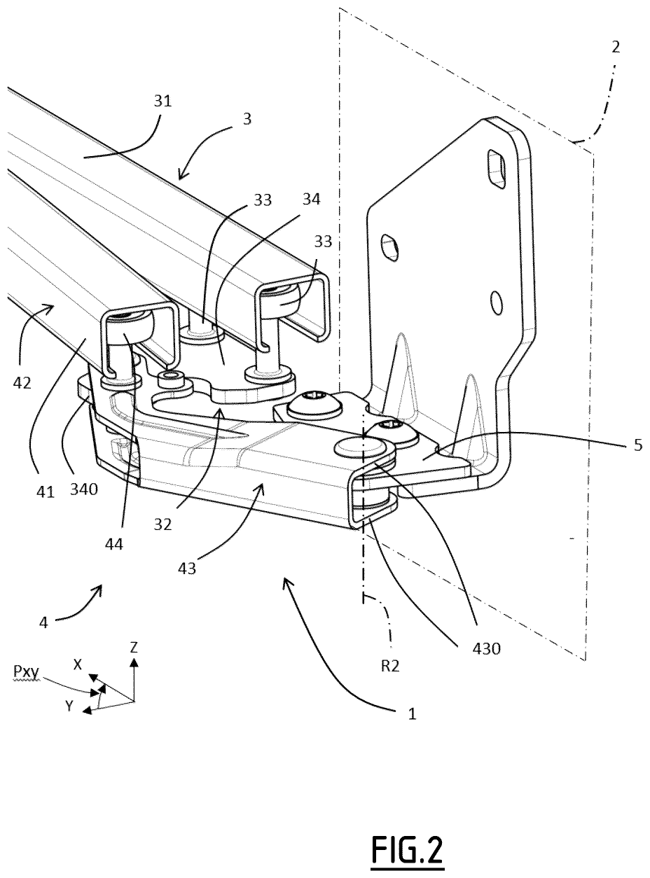

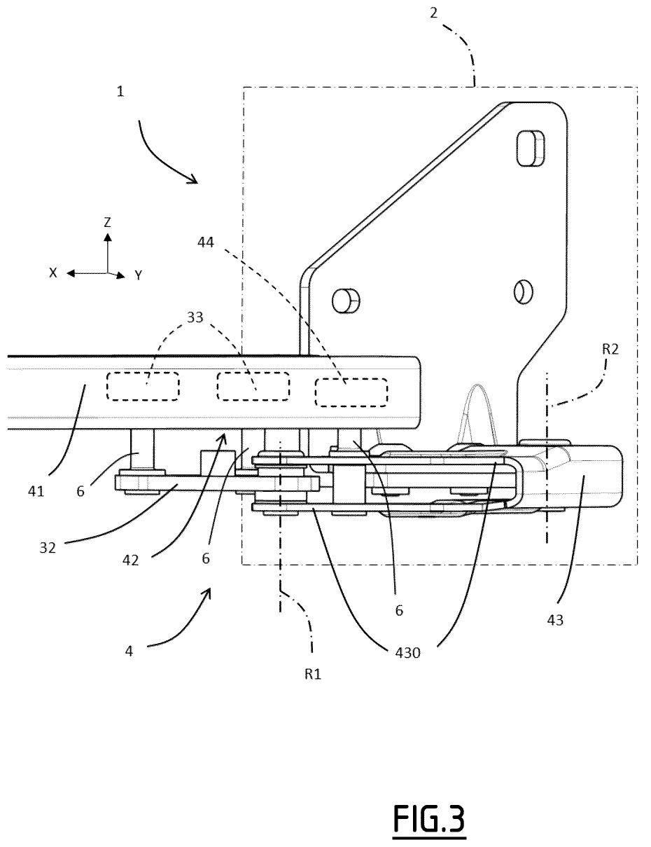

The constituent elements of the guide device 1 are shown in detail in FIG. 2 and FIG. 3, along two different planes of view. The first and second guide rails 31, 41 comprise rear portions 310, 410 which are contiguous to each other. The rear portions 310 and 410 are parallel to each other and have a substantially rectilinear profile, which makes possible the integration on the body at the door frame delimiting the opening on the body side to close. Each rear portion 310, 410 preferentially has an inverted-U-shaped cross-section, so that each rail has branches parallel to each other, in particular an inner branch parallel to an outer branch. Said axial 3 and angular 4 guiding means comprise at least one roller 33, 44 which is assembled to rotate about a rod 6 which may be cylindrical with an axis parallel to the parallel branches of each of the first and second guide rails 31, 41. The first and second rails 31, 41 can be fastened together by assembling one of the parallel branches of one of the first and second rails 31, 41 to one of the parallel branches of the other of the first and second rails 31, 41, in particular by assembling an inner branch of the axial guide rail 31 with an outer branch of the angular guide rail 41.

According to another embodiment, the fastening of the first and second rails 31, 41 can be ensured by the use of a fastening means directly mounted welded to the bottom walls of the first and second rails 31, 41, each bottom wall connecting the parallel branches of one or other of the first and second rails 31, 41.

Given the function of transversely moving the sliding door, the rollers 33 and 44 bear only against the inner faces of the parallel branches of the rails. Each roller 33, 44 is intended to pivot about a rod 6 approximately of axis Z when the guide device 1 is positioned on the body of the vehicle.

The first rail 31 is connected to two rollers 33 arranged inside the first rail. The rod 6 comprises a top portion at which the roller 33 is positioned. The opposite end is assembled through a plate 34. The plate 34 including the rollers 33 and the rods 6 define a carriage 32 intended for longitudinal sliding. The plate 34 comprises an off-centered portion 340 which is in communication with the angular guiding means 4. Such relationship is achieved by a first rotation shaft coaxial with a first rotation axis R1 which enables the connecting arm 43 to pivot about an axis Z on the carriage 32.

The second rail 41 is connected to a roller 44 arranged inside the second rail. The rod 6 comprises a top portion at which the roller 44 is positioned. The opposite end of the rod 6 is assembled through the connecting arm 43.

The connecting arm 43 comprises two parallel branches 430, which aims to improve the rigidity of the rotational assembly with the carriage 32 and the mounting plate 5, respectively.

As shown in FIG. 2, the connection apt to rotate about a second axis of rotation R2 of the connecting arm 43 on the mounting plate 5 can thus be made via a second rotation shaft, of cylindrical section, coaxial with the second axis of rotation R2, extending through the parallel branches 430 of the connecting arm 43. The rotational connection R2 can be made via a ring forming a bearing and surrounding the second shaft, while being arranged between the parallel branches 430. The ring may be made by overmolding the mounting plate 5, at a through opening coaxial with the ring. The second shaft can be positioned and then crimped onto the connecting arm 43 after the mounting plate 5 has been placed inside one end of the connecting arm 43.

The first and second axes of rotation R1 and R2 are substantially parallel to the axis Z.

As shown in FIG. 3, the rod 6 of the roller 44 fully extends through each of the parallel branches 430. The rotational connection R1 of the connecting arm 43 on the carriage 32 can thus be made via a cylindrical shaft extending through the parallel branches 430 of the connecting arm 43. The rotational connection R1 can be made via a ring forming a bearing and surrounding the cylindrical shaft, while being arranged between the parallel branches 430. The ring may be made by overmolding the plate 34 of the carriage 32, at a through opening coaxial with the ring. The cylindrical shaft can be positioned and then crimped onto the connecting arm 43 after placing the plate 34 inside an end of the connecting arm 43 opposite the end of the rotational connection R1.

The connecting arm 43 can be made by folding a steel plate. [The connection] comprises a portion of substantially U-shaped cross-section inclined so that the parallel branches extend along an axis Y and so that the lateral wall, in particular an inner lateral wall, connecting the parallel branches extends in a plane substantially of axis Z. The parallel branches 430 of the connecting arm 43 can each extend substantially parallel to the bottom portions of the first and second rails 31, 41.

The design of the connecting arm 43 of substantially U-shaped cross-section serves to compact the assembly since the movement of the connecting arm 43 around the carriage 32 or the mounting plate 5 can be achieved by placing same, in full or in part, inside the connecting arm 43, at least between the parallel branches 430. The connecting arm 43 has a substantially J-shaped longitudinal profile with a rectilinear portion of U-shaped cross-section and an inclined portion having no lateral wall connecting parallel branches 430.

The door 2 is rigidly attached to a bracket which is directly mounted on the mounting plate 5 and assembled by screw fastening. In FIG. 2, the door 2 is in a closing position, the mounting plate 5 extends partly inside the connecting arm 43. In the closed position of the door 2, the mounting plate 5 is arranged longitudinally to the extension of the plate 34 of the carriage 32, i.e. one to the extension of the other along an axis X. Due to the rotational connection R2 connecting the connecting arm 43 to the mounting plate 5, the mounting plate 5 is apt to take a position substantially at 90° with respect to the connecting arm 43. In the open position of the door 2, the mounting plate 5 is arranged transversely to the continuation of the plate 34 of the carriage 32, i.e. one to the continuation of the other along an axis Y, or even in lateral contact. Thereof improves the compactness of the guide device, the mounting plate 5 being apt for being laterally joined to the carriage 32.

The angular guiding means 4 of the connecting arm 43 comprises the second rail 41, a sloped portion 42 of which delimiting the front end of the second rail 41 is transversely distanced from the front free end of the first rail 31. The sloped portion 42 thereby forms a constant or evolving angle with the first rail in towards the inside of the passenger compartment of the vehicle. The sloped portion 42 may be rectilinear or curved while extending in a plane Pxy. The presence of such angle allows the connecting arm 43 to rotate about the point of rotation R1 so that when the roller 44 is in the sloped portion 42, the connecting arm pivots all the more as the transverse gap of axis Y between the first and second rails 31, 41 is large.

The first and second rails 31, 41 are made separately and by folding steel sheet, in particular formed from stainless steel.

According to a variant of embodiment, the first and second rails 31, 41 are made of plastic, in particular by injection molding. The first and second rails could be directly produced by molding a plastic material into an element intended to be directly mounted on the side of the vehicle body, in particular a footboard, which would facilitate the integration thereof.

According to another variant of embodiment, the first and second rails 31, 41 belong to a rail module which can be produced by extrusion of an alloy, in particular an aluminum alloy, in particular by means of an extrusion nozzle with an evolving profile to create the rectilinear and curved portions.

The first and second rails 31, 41 then form a module of rails made in one piece, which makes same easy to mount on a vehicle.

The guide device 1 has a compact design, at least along at least one vertical component. Same makes it possible to place the rear of the door 2 close to an edge of the vehicle bodywork while bringing the front of the door 2 flush with the vehicle bodywork during the closing thereof and to move the door 2 away from the bodywork during the opening thereof.

Due to the compact character thereof, such a guide device can be arranged at the upper or lower level of the opening on the side of the body, so that the means participating in the lateral travel of the sliding door 2 can be more easily integrated into a vehicle, which improves the effective volume of the latter, in particular in terms of roominess.

Such a guide device 2 makes it possible to obtain a reduced transverse and vertical bulk volume, independent of the lateral offset needed for opening the door. Indeed, in the door guide device according to the invention, the transverse offset of the door is a function of the sloped portion of the second rail and not of the advance of the guide rail inside the passenger compartment. Such device makes it possible to obtain a large lateral travel of the door but with a small transverse offset of the second rail due to the angle formed between the sloped portion of the second rail and the first rail. The travel of the door 2 is obtained by rotating the connecting arm 43 connecting the door to the articulation device 1 about a double rotational linkage R1 and R2, and about the carriage 32 and the mounting plate 5, respectively.

The small transverse and vertical bulk volume of the guide device makes it possible to produce a cavity, of low depth and height, for receiving the first and second guide rails, which makes same less visible from the inside of the passenger compartment, or less intrusive in the floor of the vehicle, which is an advantage sought after in particular in the scenario of an electric vehicle according to which a battery module is arranged under the floor. The small bulk volume of the device also makes it possible to retain a front pillar of large cross-section providing good resistance in the event of an impact. Such resistance to impact can also be easily reinforced by the use of a door box of great depth permitted by the considerable lateral travel provided by the guide device according to the invention.

The guide device according to the invention also has the advantage of making it possible to easily change the trajectory of the door by modifying only the trajectory of the sloped portion 42 of the second guide rail 41.

Of course, the invention is in no way limited to the embodiment described and illustrated, which has been given only as an example. As an example, according to a variant of embodiment, such a guide device could also integrate a supporting roller, in particular in mechanical relation with the carriage so that part of the weight of the sliding door can be distributed at the first rail, which would then have a suitable design, e.g. by resorting to a greater thickness of material.

On the other hand, the invention comprises all the technical equivalents of the means described as well as the combinations if same are carried out in the spirit thereof.

1. A guide device for a sliding door of a vehicle, consisting of at least comprising an axial guide comprising:
a first substantially rectilinear rail along which a carriage slides; and
an angular guide comprising:
a second rail, having a sloped portion with respect to said first rail; and
a connecting arm connecting to the door, wherein said first rail extends in a plane wherein moves said second rail in such a way that the connecting arm connecting the door to the guide device extends only under each of said first and second rails.

2. The guide device according to the claim 1, wherein said first and second rails each comprise a rear portion, and wherein said first and second rails are assembled together, by welding, at the said rear portions.

3. The guide device according to claim 1, further comprising a rail module comprising said first and second rails, the rail module being manufactured by a folding operation of sheet steel, in such a way that the module has a rear rail portion with a substantially rectilinear profile.

4. The guide device according to claim 1, wherein each of said first and second rails comprises a substantially inverted-U-shaped profile with parallel branches, and wherein one of the parallel branches of one of said first and second rails is connected directly to one of the parallel branches of the other of said first and second rails.

5. The guide device according to claim 1, wherein the carriage is slidably mounted along said first rail by means of a pair of rollers connected to a plate extending under each of said first and second rails, the plate comprising an off-centered portion on which a rotational connection is positioned in relation to said angular guide.

6. The guide device according to claim 1, wherein said angular guide comprises a roller connected to said connecting arm and mounted to slide along said second rail in such a way that movement of the roller along the sloped portion of said second rail generates a rotation of said connecting arm about the carriage about a first axis of rotation.

7. The guide device according to claim 6, wherein the carriage is slidably mounted along said first rail by means of a pair of rollers connected to a plate extending under each of said first and second rails, the plate comprising an off-centered portion on which a rotational connection is positioned in relation to said angular guide, and wherein said connecting arm comprises branches parallel to each other, one end of said connecting arm being connected to said axial guide by means of a second axis of rotation coaxial with the first axis of rotation and an opposite end of said connecting arm being connected to the door by means of a mounting plate connected to a rotation shaft coaxial with a third axis of rotation and fastened onto the door, each of the first and second rotation shafts extending perpendicularly through said parallel branches.

8. The guide device according to claim 7, wherein the opposite end of said connecting arm comprises a portion of substantially U-shaped cross-section

9. The guide device according to claim 1, wherein the mounting plate, said connecting arm and the carriage extend respectively in planes parallel to each other, under each of said guide rails.

10. The guide device according to claim 1, wherein the carriage is slidably mounted along said first rail by means of a pair of rollers connected to a plate extending under each of said first and second rails, the plate comprising an off-centered portion on which a rotational connection is positioned in relation to said angular guides, wherein each of the rollers is mounted on a rod, and wherein the height of the rollers is less than the height of parallel branches of said first and second rails, so that the gap, separating the mounting plate and/or said connecting arm and/or the carriage from said first rail and/or said second rail is variable in order to make possible an adjustment of the door relative a body side opening.

11. A vehicle having comprising:
a sliding door; and
a body side delimiting an opening closed by said door, comprising a guide device according to claim 1.

12. The guide device according to claim 1, wherein said angular guide comprises a roller connected to said connecting arm and mounted to slide along said second rail in such a way that the movement of the roller along the sloped portion of said second rail generates a rotation of said connecting arm about the carriage, about a first axis of rotation, wherein each of the rollers is mounted on a rod, and wherein the height of the rollers is less than the height of parallel branches of said first and second rails, so that the gap separating the mounting plate and/or said connecting arm and/or the carriage from said first rail and/or said second rail is variable in order to make possible an adjustment of the door relative a body side opening.
